(19) United States
(12) Patent Application Publication
(10) Pub. No.: US 2002/0009360 A1
(43) Pub. Date: Jan. 24, 2002

(54) Crane gear for the transport of web rolls

(76) Inventors: Joerg Christian Thies, Dissen (DE); Andreas Schroedter, Ladbergen (DE)

Correspondence Address: JACOBSON HOLMAN PLLC, 400 SEVENTH STREET N.W., SUITE 600, WASHINGTON, DC, 20004, US

(21) Appl. No.: 09/906,739

(22) Filed: Jul. 18, 2001

(30) Foreign Application Priority Data
Jul. 18, 2000 (DE) 100 34 909.9
Aug. 28, 2000 (DE) 100 42 183.0

(51) Int. Cl. B25J 1/00; B66C 3/00

(52) U.S. Cl. 414/785; 414/754

(57) ABSTRACT

A crane gear for the transport of web rolls with a winding core, provided with a passage hole, exhibits a support frame, which is attached to a cable and which is provided with receiving units. The support frame comprises an upper yoke carrier with legs, which point in the downward direction and whose ends are provided with hooks and from which a support rod, which is slid through the passage hole, can be suspended.

The invention relates to a crane gear for the transport of web rolls with a winding core, provided with a passage hole, preferably for the transport of paper rolls, with a support frame, attached to a cable, with receiving units.

Web rolls, for example made of paper, that can exhibit a weight of one ton and more, are usually transported by means of floor conveyors, for example fork lift trucks, provided with a carrying mandrel, in order to put them, for example, into unwinding units. Paper webs are drawn off, for example, from paper rolls, suspended in unwinding units, in order to produce from them tubular sections for the purpose of producing sacks or to print on them in the printing machines. It is difficult, especially under crowded room conditions, to maneuver a roll of paper hanging from a receiving mandrel of a fork lift truck.

The invention proceeds from the recognition that in the typical operations and production halls there are cranes, which can be moved to arbitrary places in the halls. Moreover, it is easier to maneuver the paper rolls, hanging from a crane hook; and thus it is easier to transport them to the unwinding units and optionally they may be conveyed away from the unwinding units.

Therefore, the object of the invention is to provide a crane gear of the class described in the introductory part of the specification, into which it is easy to suspend the web rolls and from which it is easy to remove again the web rolls from the same.

The invention solves this problem in that the support frame of the crane gear comprises an upper yoke carrier with legs, which project in the downward direction and whose ends are provided with hooks. A support rod, slid through the passage hole, can be suspended from the legs. Thus, the inventive crane gear comprises in its simplest design a U-shaped support frame with downwardly projecting legs, with which the ends of the support rod that protrude on both sides beyond the passage hole of the web roll can be coupled together.

For the purpose of attaching the web roll to the support frame and also of uncoupling it again from the same, a preferred embodiment provides that the yoke carrier is designed as a cable guide, in which a boom rod can be slid. One end of said boom rod that projects beyond the yoke carrier is connected to a support arm, projecting in the downward direction. And one end of the support rod can be coupled to the support arm, while the other end lies in such a manner in the hook of a leg that the support rod can be forced into engagement with the hook of the other leg by moving the support arm and the boom rod through the passage hole. In this inventive improvement the outer end of the support rod is connected to the support arm of the extended boom rod, whereby the other end of the support rod rests in the hook of a leg so that the crane gear can be aligned in such a manner in relation to the paper roll over the crane that the boom rod lies in front of the passage hole and aligns with said hole. By simply moving the support arm with boom, the support rod can be slid in such a manner through the passage hole of the web roll that it engages in such a manner with the hook of the other leg that the legs enclose the paper roll and the support rod is suspended from its hook.

The eye of the crane gear is located in principle in the vertical center plane between the legs of the support frame. If, however, the boom is extended to one side, said boom exerts on the support frame a moment that tries to swing the support frame into an inclined position, in which it is difficult to simply attach the web roll. Therefore, an inventive further development provides that a guide rod, which runs parallel to the yoke carrier, is attached to the brackets of the yoke carrier. On the guide rod can be slid a counterweight, which is connected in such a manner to the boom rod by means of connecting means that the crane gear is located in almost all outward thrust positions of the boom rod essentially in the balance of moments about a horizontal cross axis, running through the eye. Thus, a support frame that is provided with the inventive counterweight can be coupled in a simple manner to the web roll, because in every position of the boom the legs, provided with hooks, are located, as a rule, in their vertical position.

Preferably the connecting means comprise a cable, whose ends are fastened to the yoke carrier or the brackets and whose strands are reeved, like a block and tackle, on both sides of a fixed point to the boom rod between rollers, located on both sides of the counterweight and the yoke carrier or the brackets. In this design the counterweight is automatically coupled in such a manner to the boom rod by means of the cable reeving that, when the boom rod is moved, the counterweight exerts a movement, opposite the movement of the boom rod.

One embodiment of the invention is explained in detail below with reference to the drawings.

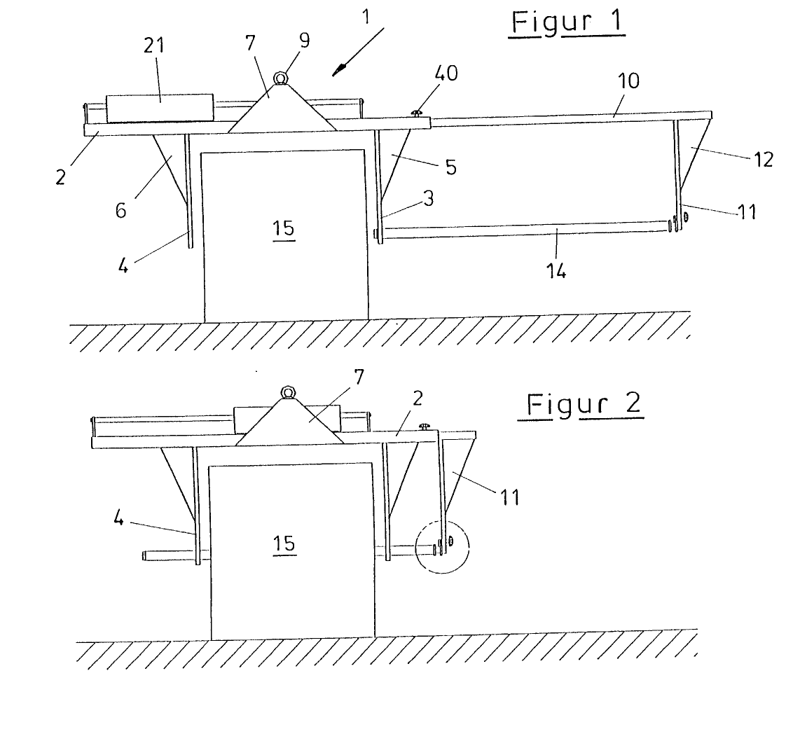

FIG. 1 is a front view of the crane gear with extended boom rod.

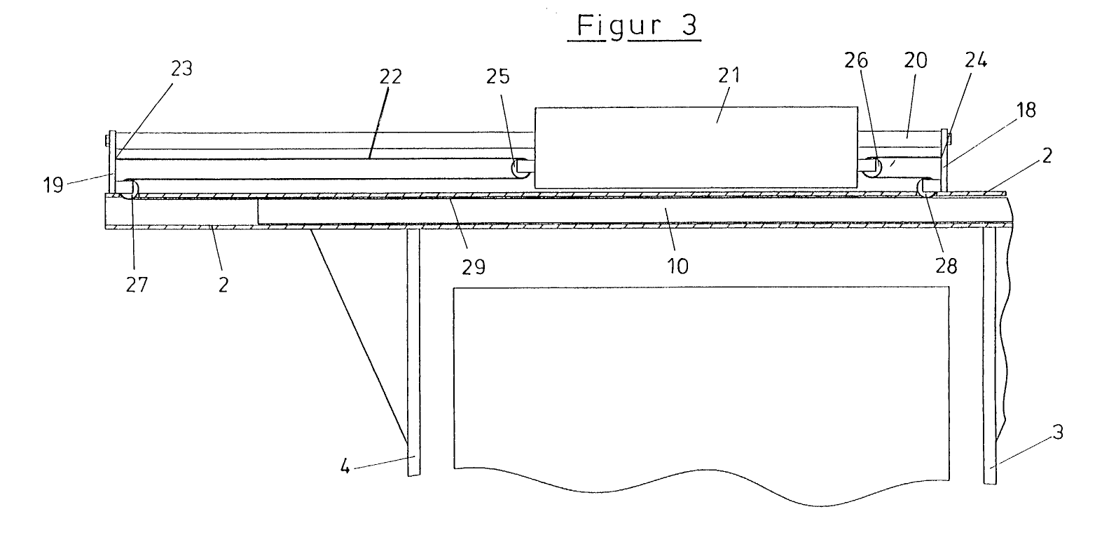

FIG. 2 is a view of the crane gear that corresponds to that of FIG. 1, with retracted boom rod and support rod, inserted into the hooks of the crane gear.

FIG. 3 is a sectional view through the yoke carrier of the support frame with a counterweight, which can be moved on the guide rod.

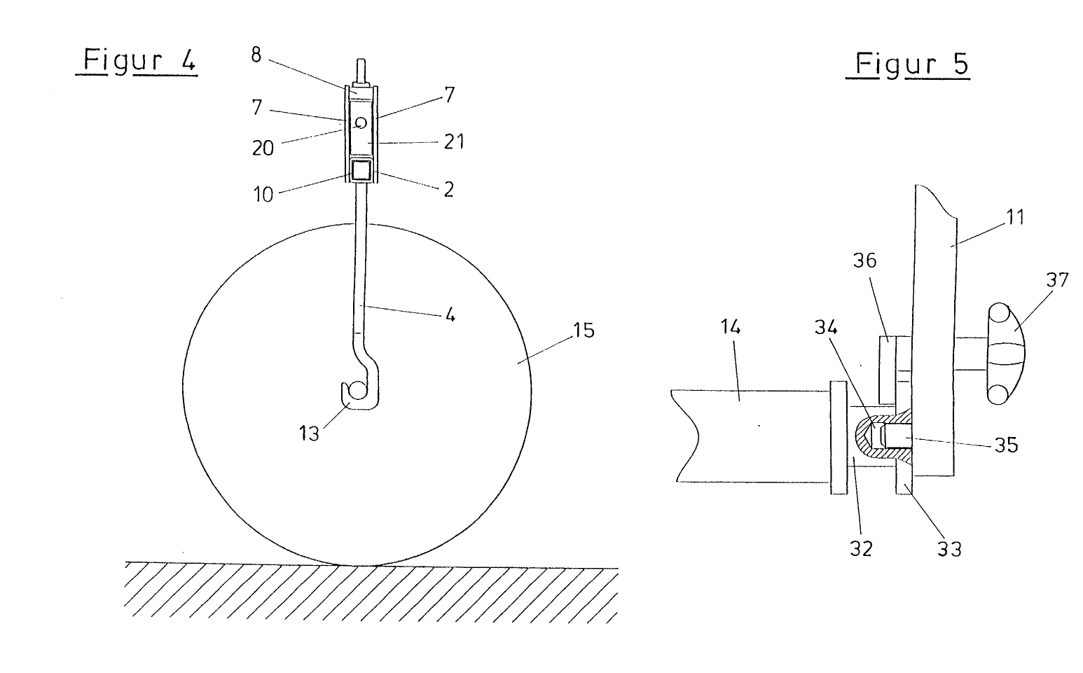

FIG. 4 is a side view of the crane gear in accordance with FIGS. 1 and 2; and

FIG. 5 is a side view of the coupling between the support arm and the support rod, partially cut.

The crane gear 1 exhibits a support frame, which comprises an upper yoke carrier 2, which is welded at right angles to the legs 3, 4, pointing in the downward direction. The yoke carrier is made from a hollow profile, for example a box profile. For reinforcement, triangular reinforcement plates 5, 6 are welded on the outsides of the legs 3, 4 to said legs and the yoke carrier 2. On both sides the yoke carrier 2 projects beyond the legs 4. In the center between the legs 3, 4 the yoke carrier is welded to triangular brackets 7, whose upper ends are connected together by means of a cross member 8, which exhibits the eye 9, from which a crane hook can be suspended.

The yoke carrier 2 exhibits a boom rod 10 with a complementary profile, whose end, projecting beyond the yoke carrier 2, is welded at right angles to a support arm 11, which is reinforced by means of a welded reinforcement plate 12 in relation to the boom rod 10.

The bottom ends of the legs 3, 4 are provided with hooks 13. A support rod 14 can be slid or hooked and/or unhooked into the hooks 13. To slide into or through a passage hole of the winding arm of the web roll 15, said support rod is coupled in such a manner, as shown in FIG. 1, to the bottom end of the support arm 11 that the opposite end of the support rod 14 rests in the hook 13 of the leg 3. To receive the web roll 15, the support frame is moved by means of the crane into a position to the web roll, in which the support rod 14 aligns with the passage hole of the winding core. After this alignment the boom rod 10 can be inserted with the support arm 11 so that the front end area of the support rod is slid, as depicted in FIG. 2, through the hook 13 of the leg 4 so that the web roll 15 is coupled, as shown in FIG. 2, to the crane gear.

The upper side of the yoke carrier 2 is welded to the brackets 18, 19, of which the bracket 19 is located on the end area of the end of the yoke carrier 2 that projects beyond the leg 4. A guide rod 20, which runs parallel to the yoke carrier 2, is held in the brackets 18, 19. A counterweight 21 can be slid longitudinally along this guide rod 20. To enable a low friction displacement, the counterweight 21 can be provided in a passage hole with spherical sleeves, by means of which the counterweight is guided on the guide rod 20. To slide the counterweight 21 on the guide rod 20, there is a cable reeving along the line of a block and tackle. This cable reeving comprises a belt or a cable 22, whose ends are attached to the fixed points 23, 24 of the brackets 18, 19. The counterweight 21 is provided on the opposite sides with forked bearing legs, in which the guide rollers 25, 26 can be freely rotated. In the base area of the brackets 18, 19 there are guide rollers 27, 28, which can be freely rotated between the forked bearing legs. These guide rollers penetrate in recesses the upper wall so that the bottom strands of the cable 22 run inside the yoke carrier. The cable 22 is connected inside the yoke carrier 2 to the boom rod 10 at a fixed point 29.

The left strand of the cable 22 runs from this fixed point 29 over the deflecting rollers 27, 25 to the fixed point 23 on the yoke 19. The right strand of the cable 22 runs from the fixed point 29 to the boom rod 10 over the deflecting rollers, 28, 26 to the fixed point 24 on the right yoke 18. This described reeving of the cable 22 guarantees that the counterweight executes a movement opposite to that of the boom rod when the boom rod 10 is moved.

The cable reeving and the configuration of the counterweight 21 on the guide rod 20 is chosen in such a manner that the counterweight generates in every position of the boom rod 10 an identically large, but opposite torque about the eye 9 so that the legs 3, 4, attached at right angles to the yoke carrier 2, always remain in their perpendicular position. Thus, this arrangement makes it easy to couple the crane gear to the web roll to be received.

As apparent from FIG. 5, the right end of the support rod 14 exhibits a section 32, whose cross section tapers off and whose end bears a flange-shaped disk 33. The tapered section 32 is provided with an axial blind hole 34, with which a pin 35 interacts that is welded to the bottom end area of the support arm 11. In the support arm 11 there is a rotatable bolt 36 above the pin 35. To actuate said bolt, it is provided with a knob 37 and can be rotated between its locking position, which is depicted in FIG. 5, and its position, releasing the flange 33. To lock, the pin 35 is slid into the borehole 34. Unlocking is done by releasing the flange 33 by means of the bolt 36 so that the pin 35 can be pulled out of the borehole 34.

A setscrew 40, provided with a knob, can be screwed into a threaded borehole of the yoke carrier 2. The boom rod 10 can be fixed into its retracted and extended position by means of said setscrew.

1. Crane gear (1) for the transport of web rolls (15) with a winding core, provided with a passage hole, preferably for the transport of paper rolls, with a support frame, attached to a cable, with receiving units,
characterized in
that the support frame comprises an upper yoke carrier (2) with legs (3, 4), which project in the downward direction and whose ends are provided with hooks (13) and from which can be suspended the support rod (14), which is slid through the passage hole.

2. Crane gear, as claimed in claim 1, characterized in that the yoke carrier (2) is designed as a cable guide, in which is moved a boom rod (10),
whose one end, which projects beyond the yoke carrier (2), is connected to a support arm (11), projecting in the downward direction; and that one end of the support rod (14) can be coupled to the support arm (11), while the other end lies in such a manner in the hook (13) of a leg (4) that the support rod (14) can be forced into engagement with the hook (13) of the other leg (4) by moving the support aim (11) with the boom rod (10) through the passage hole.

3. Crane gear, as claimed in claim 1 or 2, characterized in that attached to the brackets (18, 19) of the yoke carrier (2) there is a guide rod (20), which runs parallel to said yoke carrier, and on which can be slid a counterweight (21), which is connected in such a manner to the boom rod (10) by means of connecting means (22) that the crane gear is located in almost all extended positions of the boom rod (10) essentially in the instantaneous equilibrium about a horizontal cross axis, running through the eye (9).

4. Crane gear, as claimed in claim 3, characterized in that the connecting means comprise a belt or cable (22), whose ends are fastened to the yoke carrier (2) or the brackets (18, 19) and whose strands are reeved, like a block and tackle, on both sides of a fixed point (29) to the boom rod (10) between rollers (25, 27, 26, 28), located on both sides of the counterweight (21) and the yoke carrier (2) or the brackets (18, 19).
